(19) United States
(12) Patent Application Publication
(10) Pub. No.: US 2006/0075034 A1
(43) Pub. Date: Apr. 6, 2006

(54) Method and apparatus for creating and storing personal information relating to earth shaking events

(76) Inventors: Harri Lakkala, Tampere (FI); Riku Suomela, Tampere (FI); Ilkka Salminen, Tampere (FI)

Correspondence Address: MORGAN & FINNEGAN, L.L.P., 3 World Financial Center, New York, NY, 10281-2101, US

(21) Appl. No.: 10/949,568

(22) Filed: Sep. 24, 2004

(51) Int. Cl. G06F 15/16

(52) U.S. Cl. 709/206

(57) ABSTRACT

An apparatus and method for creating, storing, retrieving and sharing personal information relating to earth shaking events (ESE). Upon receiving notice of an ESE, a user device may create an ESE data set by creating a name/description, creating metadata and collecting information relating to the event. The parameters of the collecting process, such as the period of collection, the type of data collected, the data sources, etc., may be defined by an action profile, which is associated with the type of the event of interest. The device may also notify peer devices of the event. An ESE data set may be stored locally or remotely in association with the metadata for later retrieval. An ESE data set may be retrieved for presentation to the user and/or for sharing with peer user devices thereby enabling one to relive the user's experience relative to the event.

### FIELD OF THE INVENTION

The present invention relates to communications systems in general and, more particularly, to a user device for creating, storing and using personal information relating to a real world event.

### BACKGROUND OF THE INVENTION

People often find it interesting to reminisce about what they and others were doing when some major “earth shaking” event (“ESE”) occurred in their lives. An ESE may be anything ranging from a global or national scale event, such as the September 11^{th} terrorist attack, to a perhaps more personally meaningful event. For example, a grandfather may be more interested in knowing what he was doing when his grand child was born than what he was doing when the terrorist attack occurred.

Reminiscing about an ESE may be prompted by some external environmental stimuli that we encounter, such as sights, sounds, smells and the like. Perhaps more frequently, however, such reflection may result from our conversations with people we know or meet. For example, it is not uncommon to be asked by someone what we were doing at the time an ESE occurred.

Currently, we must rely on our own less than perfect memories to recall, not only the details of the ESE, but also our personal information relating to it—namely, where we were at the time, what we were doing, whom we were with, etc. Alternatively, we are left to devise our own methods for recording and storing such information for later retrieval. For example, we may write a diary or journal entry about an ESE, take a photograph and label it according to the event, etc. Nevertheless, we then have to remember both that we recorded such information and where we stored it, again being left to the mercy of our memories.

What is needed is a mechanism to facilitate an individual's creation, storage and presentation of information relating to ESEs and his sharing of such information with others.

### SUMMARY OF THE INVENTION

The above-identified problems are solved and a technical advance is achieved in the art by an apparatus and method for creating a data set relating to a real-world event.

An exemplary method for a user device to create a data set relating to an event, includes: observing an event; creating metadata relating to the event; collecting data to generate a data set relating to the event; and adding the metadata to data of the data set. In one embodiment, observing notice of an event may include receiving notice of the event from, e.g., a third-party, such as a news service provider. Additionally, the exemplary method may further include observing a profile for generating the data set relating to the event and collecting the data in accordance with the profile.

Other and further aspects of the present invention will become apparent during the course of the following description and by reference to the attached drawings.

### BRIEF DESCRIPTION OF THE DRAWINGS

FIG. 1 is a block diagram illustrating an exemplary arrangement between various network entities for facilitating the creation, storage and use (e.g., presentation and sharing) of personal information relating to an ESE in accordance with one embodiment of the present invention.

FIG. 2 is a block diagram illustrating an exemplary user device in accordance with one embodiment of the present invention.

FIG. 3 is a flowchart illustrating an exemplary process by which personal information relating to an ESE is created, stored and used in accordance with one embodiment of the present invention.

FIG. 4A is an exemplary list of ESE data set types.

FIG. 4B is an exemplary list of parameters contained in an action profile associated with an ESE data set type.

### DETAILED DESCRIPTION

In the following description of the various embodiments, reference is made to the accompanying drawings which form a part hereof, and in which are shown by way of illustration various embodiments in which the invention may be practiced. It is to be understood that other embodiments may be utilized and structural and functional modifications may be made without departing from the scope of the present invention.

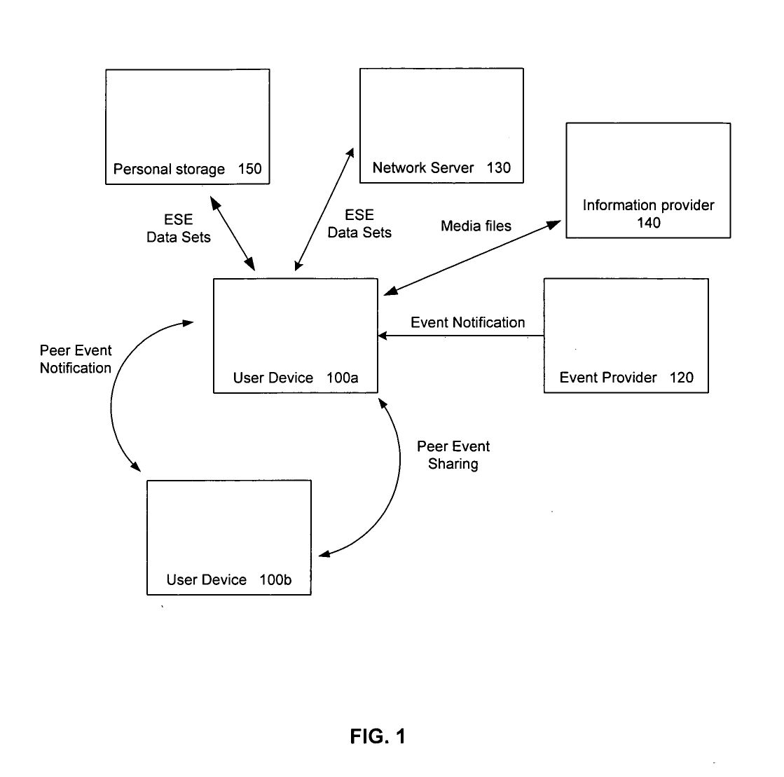

Referring now to the drawings, wherein like reference numerals refer to like parts, FIG. 1 is a block diagram illustrating an exemplary arrangement between various network entities for facilitating the creation, storage and use of personal information relating to an ESE in accordance with one embodiment of the present invention.

As shown in FIG. 1, the method of the present invention may be implemented in user device 100a. This device may be a wireless device, such as a hand-held wireless telephone, a personal digital assistant (“PDA”), a lap-top computer or the like, or a wired device such as a PC computer or set-top box (“STB). Alternatively, device 100a may be a so-called “smart” device—namely, a typical house-hold device, such as a digital camera or camcorder, a digital audio device, a television, a digital radio device, a personal video recorder, an STB, a digital video recorder (DVR), a wrist watch, a global positioning system (GPS) receiver device, a PC computer or the like, or any combination of the above, that has been enabled to communicate over a network, whether wired or wireless.

In one embodiment of the invention, user device 100a may observe a real-world event. As further shown in FIG. 1, this may comprise device 100a receiving notice of the event from an event provider 120. Provider 120 may be a news agency, a news service provider, a news paper, a magazine, a weblog, a mobile operator or any other entity that creates, receives, or compiles information concerning events for dissemination to others. Notice or messages of events may be provided using Short Messaging Service (“SMS”), Multimedia Messaging Service (“MMS”), Session Initiation Protocol (“SIP”), e-mail, digital video broadcasting (“DVB”), digital audio broadcasting (“DAB”), radio data system (“RDS”) or any other method that supports initiating a connection to, or communication with, device 100a, whether fixed or mobile.

The notice of the event may include information identifying the event, such as, e.g., a name and/or description, a location, a category of the event (e.g., world news, national news, local news, sports, etc.), etc. In one embodiment, a user of device 100a may subscribe via, e.g., SMS, MMS or a web interface, to receive such notices and specify the types of events of interest to him in accordance with a user profile. In one embodiment, rather than receiving notice from an event provider 120, the notice may be received from a user of device 100a monitoring his environment. As also shown in FIG. 1, device 100a may share notice of events with one or more peer devices 100b. As in the case of notice received from an event provider 120, notices or messages may be sent between user devices (100a, 100b) via various network services including SMS, MMS, SIP, e-mail or the like.

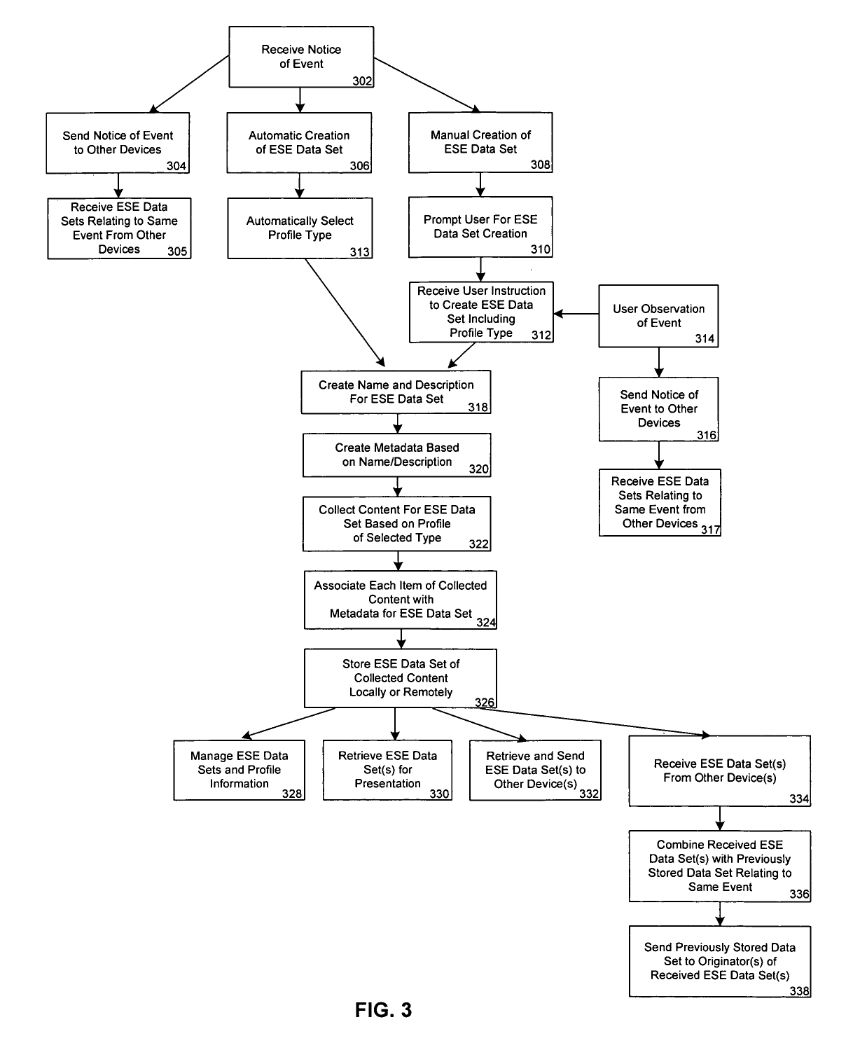

Once notice of an event has been received, user device 100a may create an ESE data set corresponding to the event, as will be discussed in detail hereinafter in connection with FIG. 3. Briefly, this may occur either automatically or in response to a user request to create an ESE data set for the event and may involve the collection and storage of content in association with metadata concerning the event. The process of collecting content may involve the user manually creating video, image, audio or text data using device 100a. Alternatively, or in addition thereto, it may involve device 100a automatically sensing context information using sensors that are either integral or peripheral to the device. Alternatively still, or in addition thereto, it may involve device 100a automatically collecting and downloading content from external sources or information providers 140, such as a news provider. In one embodiment, the process of collecting content, including the parameters of the collection process, such as the period of collection, the type of content collected, etc., is determined by a predefined ESE type and, in particular, a predefined profile associated with that ESE type, which is either automatically selected by the device 100a or manually selected by the user at the time of ESE data set creation, as will be discussed in detail hereinafter in connection with FIG. 3.

As the ESE data set is being created, it may be stored in device 100a. Alternatively, or in addition thereto, a user of device 100a may remotely store all or some of the content of the data set in a network or in a personal storage device, such as a PC computer, as illustrated in FIG. 1 by network server 130 and personal storage 150, respectively. User device 100a may later retrieve an ESE data set, either from its own data storage, from personal storage 150 or from network server 130, for presentation to the user to enable him to relive the event. In addition, as further shown in FIG. 1, device 100a may share ESE data sets with one or more peer user devices 100b and, in addition, combine content from related ESEs, thereby collecting ESE data sets that relate to the same event, as will also be discussed in detail hereinafter in connection with FIG. 3. It will be appreciated that in the case where ESE data sets are centrally stored in network server 130, in one embodiment, ESE data sets may be automatically synchronized between two or more user devices (100a, 100b) that have been pre-identified to server 130 as being related for purposes of synchronization.

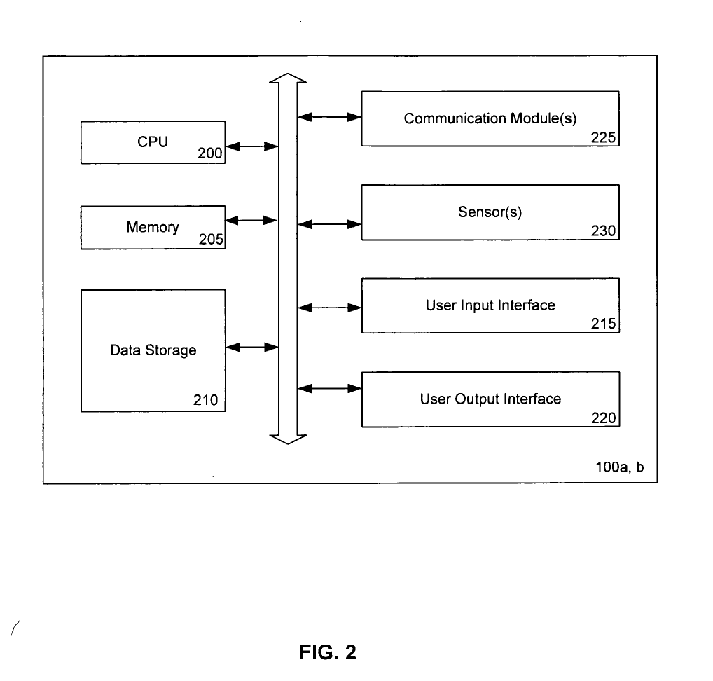

FIG. 2 is a block diagram illustrating an exemplary user device in accordance with one embodiment of the present invention. As shown in FIG. 2, user device 100 may include user input interface 215 and user output interface 220. User input interface 215 may be a keypad, which may comprise numerous function keys such as alpha-numeric keys and directional (arrow) keys, for permitting a user to perform such functions described herein as creating and presenting ESE data sets, creating and editing ESE types and associated action profiles and forwarding event notifications or ESE data sets to other devices 100b, as will all be discussed in detail hereinafter in connection with FIG. 3. User output interface 220 may be a display, which may be capable of, e.g., presenting video, image and/or textual data associated with an ESE data set to a user of device 100a.

User device 100a may also include a CPU 200 and associated memory 205 containing programming for controlling, in accordance with the present invention, data processing and transfer operations among the various elements of device 100a via a data transfer bus 250. As shown in FIG. 2, device 100a may further include a user data storage 210 for, among other things, storing ESE data sets and/or ESE action profiles that the user has created or received from other devices 100b, as will also be discussed in detail hereinafter in connection with FIG. 3.

As further shown in FIG. 2, user device 100a may also include communication module(s) 225 for communicating with peer user device 100b, an event provider 120 and/or a network server 130 or personal storage device 150 or the like, to obtain, e.g., ESE data sets, ESE action profiles, event notifications, content for use in creating ESE data sets, etc., via, in one embodiment, a wireless network service. Such services may include a short range wireless network such as a Personal Area Network (e.g., IRDA or Bluetooth PANs), a wireless LAN (e.g., wireless IEEE 1394, IEEE 802.11 or HiperLAN/2), a mobile WAN (e.g. GPRS, GSM, UMTS, etc.) or broadcast networks (e.g., digital television including any Digital Video Broadcasting standard or digital radio including Digital Audio Broadcasting. Alternatively, or in addition thereto, communications(s) module 210 may include the necessary hardware and functionality to obtain data such as event notifications and content over a wired connection, rather than a wireless connection, using, e.g., a modem and a wired telephone connection to an Internet service provider.

Additionally, user device 100a may also include one or more sensors 230 for capturing content in creating ESE data sets. These may include one or more of a camera, a microphone, location sensors (e.g., GPS, RFID, etc.), environmental sensors (e.g., temperature, humidity, pressure, altitude, etc.), speed sensors (e.g., accelerometer), etc. One or more of these sensors may be operated automatically by device 100a and/or manually by a user of device 100a to collect content during a period of ESE data set creation, as will be discussed in detail hereinafter in connection with FIG. 3.

Moreover, user device 100a may also monitor and store information concerning its own presence information, i.e., data relating to the state of the device. These states may include, but are not intended to be limited to, “in a meeting”, “on holiday” or the like. Thus, the context of device 100a may be sensor information alone, presence information alone or any combination thereof.

It will be readily appreciated that user device 100a may also include other conventional hardware and functionality, which may be employed in operating user device 100 as a mobile phone, but which are well known to those skilled in the art, and thus, are not shown in FIG. 2.

FIG. 3 is a flowchart illustrating an exemplary process by which ESE data sets are created, stored and used in accordance with one embodiment of the present invention.

In step 302, user device 100a may observe an event. In one embodiment, an event may be observed by receiving notice of the event from a third-party, such as an event provider 120 or another user device 100b. As will be discussed in detail in connection with step 314, device 100a may alternatively receive notice of an event from a user of device 100a who has monitored his environment and detected an event. In yet an alternate embodiment, device 100a may observe an event by, e.g., using one or more of sensors 205 to measure one or more parameters, either quantitatively or qualitatively, against a threshold. For example, device 100a may observe an environmental condition at a particular location and date such as the temperature exceeding 95° Fahrenheit in New York City in April.

User device 100a may forward notice of the event to another user device 100b using any communication method including, e.g., SMS, MMS, e-mail or even voice mail. (Step 304) Notice may be forwarded either automatically or in response to a user instruction to do so after the device has prompted the user either audibly or visually to determine whether the notice should be forwarded. In one embodiment, the recipients may be specified in an action profile associated with a “type” of ESE to which the event belongs, as will be discussed in detail hereinafter in connection with step 312. In that case, a determination of ESE type, and thus, action profile, is made upon observation of the event. In an alternate embodiment, the recipients of the notice may be selected by the user, either individually or by virtue of their being members of a predefined group, from an address book installed on device 100a. This selection may be performed in advance of receiving the notice and automatically used by device 100a, or it may be performed at the time of receipt of the notice. In one embodiment, recipient devices 100b may send back different ESE data sets, as will be discussed in detail hereinafter, that relate to the event of which they received notice from device 100a. (Step 305) The ESE data sets sent back to device 100a may either have been created by devices 100b or received by them from yet other user devices.

Rather than forwarding a notice of an event, or in addition thereto, user device 100a may create an ESE data set for an event. As shown in FIG. 3, creation of an ESE data set may occur either automatically (step 306) or manually (step 308) in response to a notification or an observation of an event, e.g., from a third-party provider. If performed manually, user device 100a may prompt the user to determine whether an ESE data set should be created for the event. (Step 310) If the user decides that an ESE data set should be created, he may instruct user device 100a to create one and, more specifically, may identify the type of ESE data set that is to be created. (Step 312)

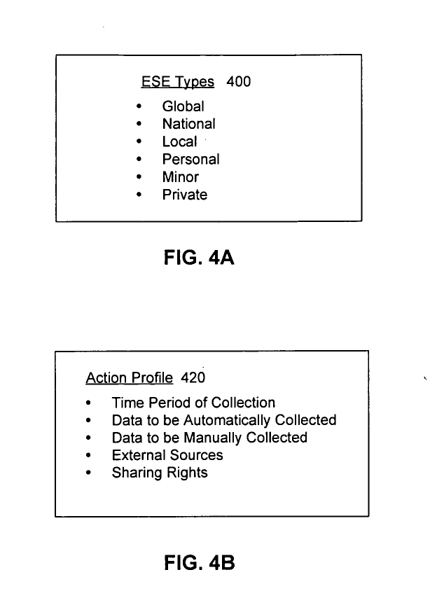

In one embodiment, an ESE data set may be one of a plurality of predefined types 400. For example, as shown in FIG. 4A, an ESE data set may be designated “Global”, “National”, or “Local”, depending upon the geographic significance of the event. An ESE data set may also be designated “Personal” for events that are personally meaningful and about which there may be little or no external information available, such as the birth of one's child. Alternatively, an ESE data set type may be designated “Minor” for events deemed to be of lesser importance to the user, but for which the user would nevertheless like to create an ESE data set. Alternatively still, an ESE data set type may be designated “Private”, for events that are not to be shared with others. It will be appreciated that the listing of ESE data set types set forth in FIG. 4A is intended to be illustrative, rather than an exhaustive, and that other data set types will readily become apparent to those of skill in the art.

It is to be understood that even in the case where an ESE data set is automatically created, device 100a may select an appropriate ESE data set type, as illustrated in step 313 of FIG. 3, based on information concerning the event contained in the notification, such as an event name, description or any metadata information, etc. For example, if the notification indicated that the event is from a category of “national news”, then user device 100a may automatically select the “national” event type for use in creating an ESE data set.

Each ESE data set type, in turn, may be associated with an action profile that defines various parameters of the ESE data set to be created, such as the time period of data collection, the type of data to be collected, the source(s) of the data, the method(s) of collection, etc. FIG. 4B illustrates an exemplary listing of parameters that may be contained in an action profile 420.

As shown in FIG. 4B, in one embodiment of the invention, a profile may include a time period indicator that describes the period of time during which data concerning the event of interest is to be collected and stored. For example, the time period indicator may be a period of time (such as one hour, one day, etc.) either before initiation of ESE data set creation or starting from initiation of ESE data set creation, or a combination thereof (i.e., both before and after initiating creation of a data set). In one embodiment, the time period is manually specified by the user at the time of ESE data set creation. Whether the time period is specified manually or by the action profile, however, the device 100a may be manually instructed by the user at any time to cease collecting content for an event.

The profile may also define the type of information to be collected and the method(s) of collection (e.g., manually, automatically or both). The manually collected, but automatically stored, information may include any video, image, audio or text files created or received by the user during the period of data collection including SMS or MMS messages, e-mails and browsed content as well as notes and other text or presentation files created or used during the period of collection. In addition, the user device 100a may prompt the user to actively collect one or more such items of information during the relevant time period, or the user may do this of his own initiative. Thus, for example, the user may type some text to memorialize his thoughts of the moment, or take a photograph or video or make an audio recording of himself and/or his surroundings.

In contrast, the automatically collected and stored information may include context information, such as that provided by one or more sensors, and/or presence information, such as a state of device 100a. As previously mentioned, the sensors may include, but are not limited to, a camera, a microphone, location sensors (e.g., GPS, RFID, etc.), environmental sensors (e.g., temperature, humidity, pressure, altitude, etc.), speed sensors (e.g., accelerometer), etc., that may be either integral or peripheral to user device 100a. Thus, in the case of a peripheral sensor, for example, device 100a may access a web camera to automatically collect video, image and/or audio data. The automatically collected data may also include information about other devices to which device 100a is connected, or in proximity of, during the period of data collection. This may be accomplished using well-known device and/or service discovery mechanisms, such as those readily available in connection with various short-range wireless protocols, such as Bluetooth.

As further shown in FIG. 4B, the profile may also define external sources (by way of, e.g., URL links) that will be contacted over a data network, such as the Internet, for purposes of downloading relevant content to user device 100a. In addition to the above-mentioned peripheral sensors, such as a web-camera, these external sources may include news providers, weather providers, television and radio broadcasters and/or the like. The content that is downloaded may be all data that is available from these sources during the period of collection or, alternatively, only relevant data specified in the action profile or discerned from the name, description or metadata of the event contained in the notification received from an event provider 120 or a peer device 100b. In this regard, the name and description or any metadata may be used by device 100a to create a query for use in retrieving relevant information from the external sources specified in the profile.

As indicated above, ESE data sets may be shared with other devices 100b. Thus, an action profile may also define the devices to which an ESE data set and/or notice of an event may be transmitted.

It will be appreciated that the information in each action profile may vary depending on the associated ESE type. For example, national events may be deemed to be most important to the user, and thus, an action profile associated with a “National” ESE type will likely specify a longer period of collection, more external data sources, etc., than the profiles of other ESE types. In a similar fashion, a profile corresponding to a “Minor” ESE type, may specify collecting data for the shortest duration and from the fewest sources in contrast with profiles associated with other ESE types.

Returning to FIG. 3, it will be appreciated that, in step 314, rather than receiving notice of an event from a third-party, a user may monitor his environment for what he deems to be a personally important event and, upon occurrence of such an event, may instruct terminal 100a to create an ESE data set of a predefined type. (Step 312) Additionally, notice of an event, whether from a third-party or from a user's monitoring of his environment, may be sent to other devices 100b either automatically or in response to a user's instruction to do so, or by instructions to do so contained in the ESE profile. (Step 316) In one embodiment, the recipients of the notice may either be members of a predefined group (e.g., “family”), which may be associated with the ESE data set type (e.g., “personal”) specified by the user or, may be selected by the user from an address book installed on device 100a. Moreover, as previously discussed in connection with step 305, device 100a may receive ESE data sets relating to the same event from other user devices that it notified of an event. (Step 317) In one embodiment, device 100a may combine data sets that it created with those that it received from one or more other devices relating to the same event.

Whether an ESE data set is created automatically or manually, in step 318, a name, and perhaps, a description or other data, such as time and date information, relating to the ESE data set is created. This, in turn, may occur either automatically or manually. For example, device 100a may automatically create a name and description from information contained in the notification received from event provider 120. Alternatively, a name and description may be manually created by the user's entering of such information via user input interface 215. Additionally, time and date information, or information concerning the location of device 100a, may be automatically created when creation of an ESE data set is initiated.

Once a name and description and/or other data have been created, in step 320, device 100a creates metadata for use in storing and later retrieving an ESE data set, as will be discussed in detail hereinafter. The metadata may be based on the name, description, time and date information, location information and/or the like. For example, exemplary metadata for an event may be “ESE: birth of first grandchild; May 12, 2004; 13:45”. After the requisite metadata has been created, then, in step 322, content for the event may be collected in accordance with the previously selected profile. In step 324, the previously created metadata is added to the collected content by way of, e.g., embedding it within the content, storing it with the content or otherwise associating it with the content. In step 326, the collected content is stored either locally in device 100a or some other personal storage device 150 or remotely in a network storage device 130 for future retrieval for either presentation to the user or for sharing with users of other devices 100b. The created ESE data set (and those collected from other devices 100b) may be stored in any form, including but not limited to, a list, a folder, a cluster, a web document, an album, a presentation or the like or any combination thereof.

As shown in FIG. 3, steps 328-338 illustrate additional exemplary functionality available to a user of device 100a in connection with the ESE data sets of the present invention. For example, in step 328, a user of device 100a may perform various housekeeping functions on the ESE data sets themselves or the predefined ESE types and/or associated action profiles. Such functions may include adding, modifying or deleting information. For example, a user of device 100a may delete an ESE data set that was automatically created, but which the user has no interest in retaining, or modify an action profile to change a parameter thereof, or delete a profile type and associated profile altogether, etc.

In step 330, a user of device 100a may retrieve one or more ESE data sets for presentation on device 100a. In one embodiment, the user may be able to select an ESE data set for presentation from a display setting forth an indicator of each data set, such as an icon, a thumbnail or the text name and/or description of the data set. The displayed information from which a selection is made may be in the form of a list, a folder, a cluster, a web document, an album or the like. Additionally, an indicator of an ESE data set may appear as one type of media file on a calendar or in a media management system or application, such as a media diary like Nokia Lifeblog, on a time-line based on date and/or time metadata that was created for the dataset.

The indicator of each ESE data set, such as the text name/and description, in turn, whether in a list, on a calendar, on a time-line, etc., is associated with the previously created metadata and it is the metadata that is used to retrieve the content for presentation to the user. Upon selecting an indicator of a particular ESE data set, the user may be provided with an indicator of all of the content that is available for the event and can select one or more of the items of content for presentation. This too may be presented in the form of a list, a folder, a cluster, a web document, an album, a presentation or the like. Similarly, the actual content of the ESE data set may be presented in the form of a list, a folder, a cluster, a web document, an album, a presentation or the like. As will be readily appreciated, presentation allows the user to easily relive the event and, in particular, recall his personal experience relative to the event. Alternatively, device 100a may use an HTTP connection to a web server and a weblogging software's API in order to post an ESE data set on-line, thereby reaching a broader audience to share in his personal experiences.

In step 332, the user may retrieve one or more of the ESE data sets for transmission to one or more other devices 100b using, e.g., MMS. Retrieval may be performed in the same manner as discussed above in connection with step 330. The intended recipients may each be selected from a list of individuals or may belong to a predefined group that the user has selected. In addition, the sharing rights associated with the action profile of the particular ESE data set sought to be shared may be observed.

In step 334, user device 100a may receive an ESE data set from another user device 100b. If the received ESE data set relates to the same event as an ESE data set already stored by device 100a, in step 336, device 100a may combine the received content with the previously stored content. This may be accomplished, e.g., by assigning the metadata of the previously stored ESE data set to the content of the ESE data set received from the peer device 100b. Alternatively, or in addition thereto, device 100a may, in turn, send the previously stored ESE data set to device 100b. (Step 338)

The many features and advantages of the present invention are apparent from the detailed specification, and thus, it is intended by the appended claims to cover all such features and advantages of the invention which fall within the true spirit and scope of the invention.

Furthermore, since numerous modifications and variations will readily occur to those skilled in the art, it is not desired that the present invention be limited to the exact construction and operation illustrated and described herein, and accordingly, all suitable modifications and equivalents which may be resorted to are intended to fall within the scope of the claims.

We claim:

1. A method for a user device to create a data set relating to an event, comprising:
observing an event;
creating metadata relating to the event;
collecting data to generate a data set relating to the event; and
adding the metadata to data of the data set.

2. The method of claim 1 further comprising:
observing a profile for generating the data set relating to the event.

3. The method of claim 2 wherein collecting data to generate the data set is performed in accordance with the profile.

4. The method of claim 1 wherein the user device is a mobile telephone.

5. The method of claim 1 wherein observing an event comprises receiving notice of the event.

6. The method of claim 5 wherein the notice is provided by a user of the user device who observed the event.

7. The method of claim 5 wherein the notice is provided by a third-party entity.

8. The method of claim 7 wherein the third-party entity is another user device.

9. The method of claim 7 wherein the third-party entity is a news service provider.

10. The method of claim 1 further comprising:
selecting the profile from a plurality of profiles based on the event.

11. The method of claim 1 further comprising:
notifying another user device of the event.

12. The method of claim 11 further comprising:
in response to notifying the other user device, receiving a different data set relating to the event from the other user device.

13. The method of claim 1 wherein the data set is automatically created.

14. The method of claim 1 further comprising:
transmitting the data set to another user device; and
in response, receiving a different data set relating to the event from the other user device.

15. The method of claim 14 wherein the data set is transmitted based on sharing rights associated with the data set.

16. The method of claim 1 further comprising:
storing the data set;
retrieving the data set from storage for presentation of the data of the data set to a user of the user device.

17. The method of claim 16 wherein the data set is stored remotely in a network.

18. The method of claim 1 further comprising:
receiving a different data set relating to the event from another user device; and
combining data of the different data set with the data of the data set generated by the user device.

19. The method of claim 1 further comprising:
creating a description of the event,
wherein the metadata is based on the description.

20. The method of claim 1 wherein the profile defines data to be collected.

21. The method of claim 1 wherein the profile defines a time period for collection.

22. The method of claim 20 wherein the data to be collected includes context information sensed by a plurality of sensors.

23. The method of claim 22 wherein the sensors are peripheral to the user device.

24. The method of claim 1 wherein the profile defines both data to be automatically collected and data to be manually collected.

25. The method of claim 20 wherein the profile further defines external sources of data to be collected.

26. The method of claim 1 further comprising:
presenting an indication of the data set on a time-line presentation.

27. A user device for creating a data set relating to an event, comprising:
a memory device for storing a program; and
a processor in communication with the memory device, the processor operative with the program to:
observe an event;
create metadata relating to the event;
collect data to generate a data set relating to the event; and
add the metadata to data of the data set.

28. The device of claim 27 wherein the processor is further operative with the program to:
observe a profile for generating the data set relating to the event.

29. The device of claim 28 wherein collecting data to generate the data set is performed in accordance with the profile.

30. The device of claim 27 wherein the user device is a mobile telephone.

31. The device of claim 27 wherein observing an event comprises receiving notice of an event.

32. The device of claim 31 wherein the notice is provided by a user of the user device who observed the event.

33. The device of claim 31 wherein the notice is provided by a third-party entity.

34. The device of claim 33 wherein the third-party entity is another user device.

35. The device of claim 33 wherein the third-party entity is a news service provider.

36. The device of claim 27 wherein the processor is further operative with the program to:
select the profile from a plurality of profiles based on the event.

37. The device of claim 27 wherein the processor is further operative with the program to:
notify another user device of the event.

38. The device of claim 37 wherein the processor is further operative with the program to:
in response to notifying the other user device, receive a different data set relating to the event from the other user device.

39. The device of claim 27 wherein the data set is automatically created.

40. The device of claim 27 wherein the processor is further operative with the program to:
transmit the data set to another user device; and
in response, receive a different data set relating to the event from the other user device.

41. The device of claim 40 wherein the data set is transmitted based on sharing rights associated with the data set.

42. The device of claim 27 wherein the processor is further operative with the program to:
store the data set;
retrieve the data set from storage for presentation of the data of the data set to a user of the user device.

43. The device of claim 42 wherein the data set is stored remotely in a network.

44. The device of claim 27 wherein the processor is further operative with the program to:
receive a different data set relating to the event from another user device; and
combine data of the different data set with the data of the data set generated by the user device.

45. The device of claim 27 wherein the processor is further operative with the program to:
create a description of the event,
wherein the metadata is based on the description.

46. The device of claim 27 wherein the profile defines data to be collected.

47. The device of claim 27 wherein the profile defines a time period for collection.

48. The device of claim 46, wherein the data to be collected includes context information sensed by a plurality of sensors.

49. The device of claim 48, wherein the sensors are peripheral to the user device.

50. The device of claim 27, wherein the profile defines both data to be automatically collected and data to be manually collected.

51. The device of claim 46, wherein the profile further defines external sources of data to be collected.

52. The device of claim 27 wherein the processor is further operative with the program to:
present an indication of the data set on a time-line presentation.

53. A system for creating a data set relating to an event, the system comprising at least two user devices in communication with one another for sharing information relating to the event, wherein a first user device comprises:
a memory device for storing a program; and
a processor in communication with the memory device, the processor operative with the program to:
observe an event;
create metadata relating to the event;
collect data to generate a data set relating to the event; and
add the metadata to data of the data set.

54. The system of claim 53 wherein the processor is further operative with the program to:
observe a profile for generating the data set relating to the event.

55. The system of claim 54 wherein collecting data to generate the data set is performed in accordance with the profile.

56. The system of claim 53 wherein the first user device is a mobile telephone.

57. The system of claim 53 wherein observing an event comprises receiving notice of an event.

58. The system of claim 57 wherein the notice is provided by a user of the first user device who observed the event.

59. The system of claim 57 wherein the notice is provided by a third-party entity.

60. The system of claim 59 wherein the third-party entity is a second user device.

61. The system of claim 59 wherein the third-party entity is a news service provider.

62. The system of claim 53 wherein the processor is further operative with the program to:
select the profile from a plurality of profiles based on the event.

63. The system of claim 53 wherein the processor is further operative with the program to:
notify another user device of the event.

64. The system of claim 63 wherein the processor is further operative with the program to:
in response to notifying the other user device, receive a different data set relating to the event from the other user device.

65. The device of claim 53 wherein the data set is automatically created.

66. The system of claim 53 wherein the processor is further operative with the program to:
transmit the data set to a second user device; and
in response, receive a different data set relating to the event from the second user device.

67. The system of claim 66 wherein the data set is transmitted based on sharing rights associated with the data set.

68. The system of claim 53 wherein the processor is further operative with the program to:
store the data set;
retrieve the data set from storage for presentation of the data of the data set to a user of the first user device.

69. The system of claim 68 wherein the data set is stored remotely in a network.

70. The system of claim 53 wherein the processor is further operative with the program to:
receive a different data set relating to the event from a second user device; and
combine data of the different data set with the data of the data set generated by the first user device.

71. The system of claim 53 wherein the processor is further operative with the program to:
create a description of the event,
wherein the metadata is based on the description.

72. The system of claim 53 wherein the profile defines data to be collected.

73. The system of claim 53 wherein the profile defines a time period for collection.

74. The system of claim 72 wherein the data to be collected includes context information sensed by a plurality of sensors.

75. The system of claim 74 wherein the sensors are peripheral to the first user device.

76. The system of claim 53 wherein the profile defines both data to be automatically collected and data to be manually collected.

77. The system of claim 72 wherein the profile further defines external sources of data to be collected.

78. The system of claim 53 wherein the processor is further operative with the program to:
present an indication of the data set on a time-line presentation.
